(19) United States
(12) Patent Application Publication
(10) Pub. No.: US 2014/0252725 A1
(43) Pub. Date: Sep. 11, 2014

(54) CLAMPING APPARATUS FOR CUTTING TOOL

(71) Applicants: Hon Hai Precision Industry Co., Ltd., New Taipei (TW); Hong Fu Jin Precision Industry (ShenZhen) Co., Ltd., Shenzhen (CN)

(72) Inventors: YI-FENG PENG, Shenzhen (CN); JUN-QI LI, Shenzhen (CN); QING LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/196,196

(22) Filed: Mar. 4, 2014

(30) Foreign Application Priority Data
Mar. 7, 2013 (CN) 2013100716712

(51) Int. Cl. B23B 31/30

(52) U.S. Cl. CPC B23B 31/30; B23B 2231/00
USPC 279/4.04

(57) ABSTRACT

A clamping apparatus includes a clamping member, a cylinder assembly and a transmission assembly. The cylinder assembly includes a cylinder, a sealing head and a limiting member. The sealing head defines a gas channel connected to the inner of the cylinder. The limiting member includes a limiting portion fixed to the cylinder, which includes an inner surface having a frustoconical shape. The clamping member is received in the limiting member, and includes a frustoconical shape clamping portion. The transmission assembly includes a piston shaft, a piston and an elastic member. The piston and the elastic member are both received in the cylinder. The elastic member is resisted between the piston and the limiting member. One end of the piston shaft away from the piston is connected to the clamping portion. The clamping member defines a clamp hole in middle.

### 1. FIELD

The present disclosure relates to clamping apparatuses, particularly to a pneumatic clamping apparatus.

### 2. BACKGROUND

A conventional clamping apparatus includes a chuck and three or four clamping claws movably mounted on the chuck, and the clamping claws move radically to hold a cutting tool in the clamping apparatus. The clamping claws and the cutting bar of the cutting tool contact tightly when clamping the cutting tool. As the contact area of the cutting tool and clamping claw is small, the clamping force should be large enough to hold the cutting tool tightly.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an assembled, perspective view of a clamping apparatus according to an embodiment of this disclosure.

FIG. 2 is an exploded view of the clamping apparatus as shown in FIG. 1.

FIG. 3 is a cross-sectional view of the clamping apparatus taken along a line II-II as shown in FIG. 1.

### DETAILED DESCRIPTION

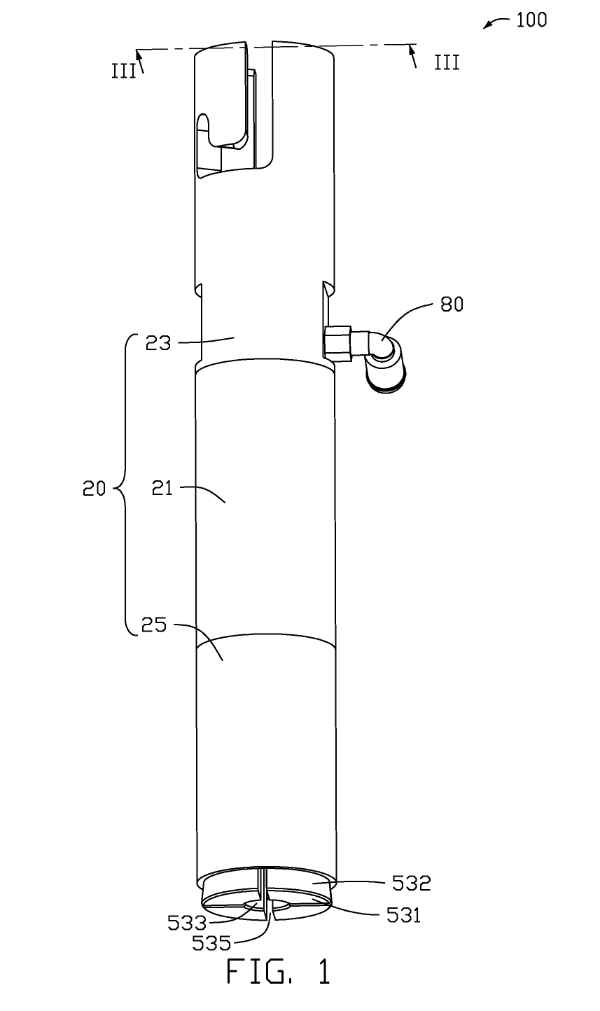

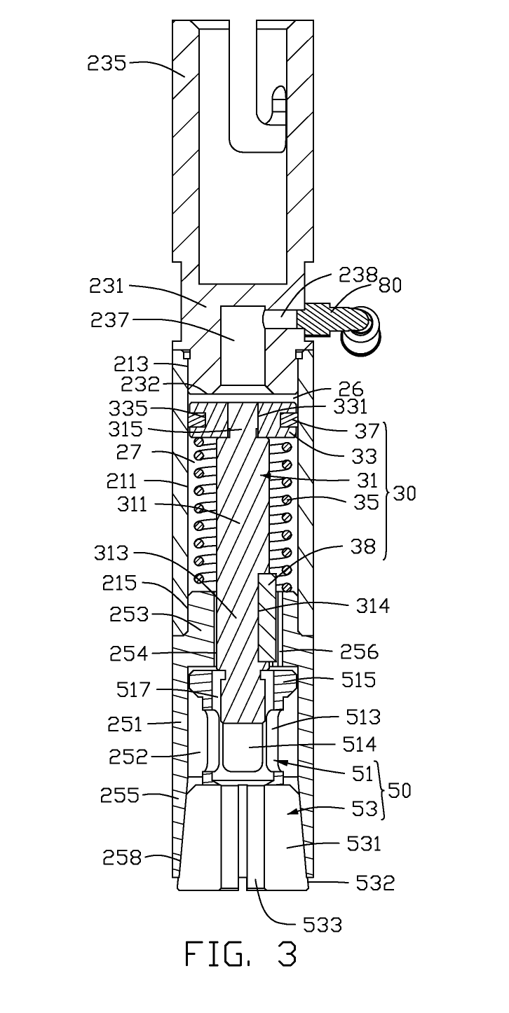

FIG. 1 and FIG. 3 show a clamping apparatus 100 of one illustrated embodiment. The clamping apparatus 100 includes a cylinder assembly 20, a transmission assembly 30, a clamping member 50, and an air port 80. The transmission assembly 30 and the clamping member 50 can both be positioned in the cylinder assembly 20. The transmission assembly 30 can be positioned substantially in the middle portion of the cylinder assembly 20, and the clamping member 50 can be positioned adjacent to one end of the cylinder assembly 20. The air port 80 is inserted onto the cylinder assembly 20, configured for connecting with an air source.

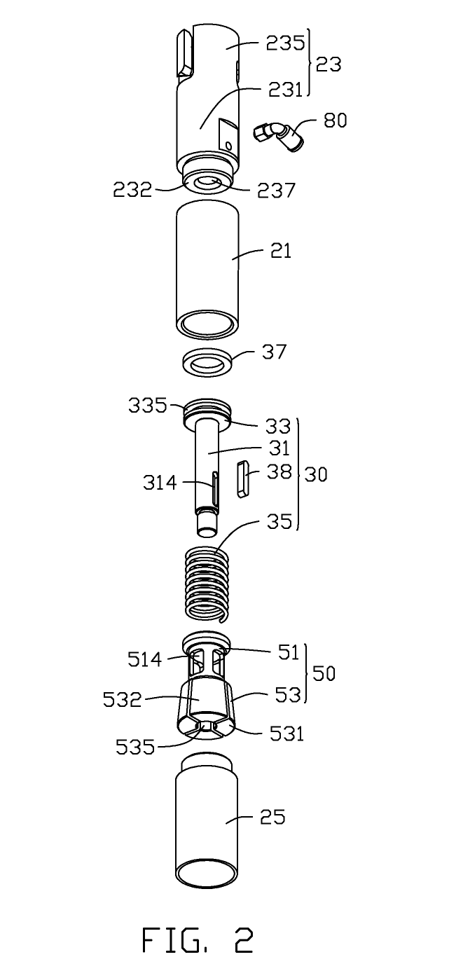

FIG. 1 through FIG. 3 show that the cylinder assembly 20 can include a cylinder 21, a sealing head 23 placed on one end of the cylinder 21, and a limiting member 25 formed on the other end of the cylinder 21. One end of the sealing head 23 can be received in one end of the cylinder 21, and the other end of the sealing head 23 can protrude from the cylinder 21. One end of the limiting member 25 can be received in the cylinder 21, and the other end of the limiting member 25 exposed.

The cylinder 21 is substantially hollow cylinder and includes an inner surface 211 extending along an axis of the cylinder 21. The cylinder 21 defines a first opening 213 and a second opening 215 at opposite ends.

The sealing head 23 can be substantially cylinder shaped, and mounted on the cylinder 21 through the first opening 213, and can be configured for sealing the first opening 213. The sealing head 23 can include a sealing portion 231 and an assembly portion 235 protruding from one end of the sealing portion 231. The end of the sealing portion 231 away from the assembling portion 225 is a connecting end 232, which can be received in the first opening 213 of the cylinder 21. The sidewall of the sealing portion 231 adjacent to the connecting end 232 can be resisted against the inner surface 211 of the cylinder 21, thereby the first opening 213 is sealed. The end surface of the connecting end 232 defines a gas channel 237 toward the assembly portion 235. The sidewall of the sealing portion 231 away from the connecting end 232 can define an access hole 238 communicating with the gas channel 237. The assembly portion 235 can extend out of the cylinder 21, and the shape of the assembly portion 235 matches with cutting tool, and is configured for mounting the sealing head 23 to the cutting tool.

The limiting member 25 can be substantially a hollow cylinder and mounted in the cylinder 21 through the second opening 215. The limiting member 25 can be formed integrally with cylinder 21. The limiting member 25 can include a receiving portion 251, a resisting portion 253 and a limiting portion 255 formed at two opposite ends of the receiving portion 251. The receiving portion 251 can extend out of the cylinder 21, and can define a first receiving hole 252, which can be cylinder-shaped through the central portion. The end of the resisting portion 253 away from the receiving portion 251 can be fixedly received in the second opening 215, and the sidewall of the resisting portion 253 adjacent to the second opening 215 can be resisted against the inner surface 211 of the cylinder 21. The central portion of the resisting portion 253 can define a second receiving hole 254 along an axis of the resisting portion 253. The second receiving hole 254 can be substantially cylinder shaped, and a diameter of the second receiving hole 254 can be smaller than a diameter of the first receiving hole 252. The sidewall of the second receiving hole 254 can define a first groove 256, which can be rectangular along an axis of the second receiving hole 254. The central portion of the limiting portion 255 can define a third receiving hole 258, which can be frustoconical along the axis. A diameter of the third receiving hole 258 adjacent to the receiving portion 251 can be substantially the same as the diameter of the first receiving hole 252, and the diameter of the third receiving hole 258 can be gradually enlarged along a direction away from the first receiving hole 252.

The transmission assembly 30 can include a piston shaft 31, a piston 33, an elastic member 37, and a guiding member 38. The piston shaft 31 can include a main body 311, a fixing end 313 extending from one end of the main body 311, and an assembly end 315 protruding from the other end of the main body 311. The main body 311 can be cylindrical shaped and received in the cylinder 21. The fixing end 313 can be cylindrical shaped, and can have a diameter substantially equal to a diameter of the main body 311. A part of the fixing end 313 can be received in the second receiving hole 254, and the other part of the fixing end 313 can be received in the first receiving hole 252. The outer surface of the fixing end 313 resists against the inner surface of the second receiving hole 254, thus the piston shaft 31 and the limiting member 25 cooperatively seal the second opening 215. The sidewall of the fixing end 313 can define a second groove 314 corresponding to the first groove 256 of the limiting member 25. The assembly end 315 can be cylindrical shaped, and a diameter of the assembly end 315 can be smaller than the diameter of the main body 311. The piston 33 can be discoid, and can be mounted on the assembly end 315 and received in the cylinder 21. An assembly groove 331 can be defined in the middle of the piston 33 along an axis, and can be configured for receiving the assembly end 315. The axis of the assembly groove 331 can coincide with the axis of the piston shaft 31. The outer surface of the piston 33 can define an annular receiving groove 335. The cylinder 21 can be divided to a first chamber 26 and a second chamber 27 by the piston 33. The first chamber 26 can be positioned between the sealing head 23 and the piston 33, and the second chamber 26 can be positioned between the limiting member 25 and the piston 33. The elastic member 35 can be sleeved on the main body 311 of the piston shaft 31, in the second chamber 27. The elastic member 35 can be resisted between the piston 33 and the resisting portion 253 of the limiting member 25. The sealing member 37 can be received in the receiving groove 335 of the piston 33, and the outer surface of the sealing member 37 can be resisted against the inner surface 211 of the cylinder 21, which can be configured for sealing the first chamber 26. A part of the guiding member 38 can be fixedly mounted in the second groove 314 of the fixing end 313. The other part of the guiding member 38 can be received in the first groove 256 of the limiting member 25, and can be slid in the first groove 256, thereby the guiding member 38 can move along the axis of the first groove 256 with the piston shaft 31. In this embodiment, the elastic member 35 is a spring, and the guiding member 38 is a guiding key. The elastic member 35 can be an elastic sleeve, or other elastic members. The guiding member 38 can be a sliding key, or other guiding members.

The clamping member 50 can be received in the first receiving hole 252 and the third receiving hole 258 of the limiting member 25, and one end of the clamping member 50 can extend out of the third receiving hole 258. The clamping member 50 can include a connecting portion 51 and a clamping portion 53 protruding on one end of the connecting portion 51. The connecting portion 51 can be substantially T-shaped, and can be received in the first receiving hole 252. The connecting portion 51 can include a main portion 513 and an end portion 515 protruding from one end of the main portion 513. The main portion 513 can be substantially hollow cylinder shaped. The peripheral wall defines four through holes 514 symmetrically positioned, and configured for increasing the elasticity of the connecting portion 51. The end portion 515 can define a limiting hole 517 through the middle portion, and a part of the fixing end of the piston shaft 31 can be fixedly mounted in the limiting hole 517. The clamping portion 53 can be mounted on the end of the main body 513 away from the end portion 515, and can be received in the third receiving hole 258 of the limiting portion 255. The clamping portion 53 can be substantially frustoconical, and a diameter of the clamping portion 53 can be gradually enlarged along the direction away from the main body 513. The clamping portion 53 can include four clamp pieces 531 evenly spaced symmetrically on the end surface of the main portion 513 away from the end portion 513, apart from each other. When not being pressed, the ends of the four clamp pieces 531 are dispersed. Each clamp piece can include a first side surface 532 and a second side surface 533 opposite to the first side surface 532. The first side surface 532 can be positioned at one side of the clamp piece 531 adjacent to the limiting portion 255, matching with the inner surface of the third receiving hole 258 which can be substantially frustoconical. The second side surface 533 can be a concave surface. The four first side surfaces 532 of the four clamp pieces 531 can define a frustoconical shape matching with the inner surface of the third receiving hole 258, and the four second side surfaces 533 can define a clamp hole 535, and can be configured for clamping the cutting tool. The clamp hole 235 can be, but not limited to, cylinder shaped. The shape of the clamp hole 235 matches the cutting tool, and the shape of the second side surface 533 matches the cutter bar. Therefore, the cross section of the clamp hole 535 can be polygonal, square, octagonal, or other shape. The size of the clamp hole 535 can be changed by choosing a different clamping portion 53, thereby the cutting tools of different specifications can be clamped.

The air port 80 can be manually inserted into access hole 238 of the sealing head 23. The sealing head 23 can be configured for connecting with a gas source (not shown) and enabling the gas to flow into the first chamber 26 through the air channel 237.

In assembly, the clamping portion 53 can be mounted on the end of the connecting portion 51 away from the end portion 515, and the fixing end 313 of the piston shaft 31 can be fixedly mounted on the end portion 515 of the connecting portion 51 through the limiting hole 517. A part of the guiding member 38 can be fixedly mounted in the second groove 314 of the fixing end 313 of the piston shaft 31. The assembly end 315 of the piston shaft 31 can be mounted on the limiting member 25 through the limiting portion 255, the receiving portion 251 and the resisting portion 253. Then the fixing end 313 can be received in the first receiving hole 252 and the second receiving hole 254 of the limiting member 25, and the main body 311 and the assembly end 315 of the piston shaft can extend beyond the limiting member 25. At the same time, the connecting portion 51 of the clamping member 50 can be received in the first receiving hole 252, and the clamping portion 53 can be partly received in the third receiving hole 258 and partly extended beyond the limiting member 25. The other part of the guiding member 38 can be assembled in the first groove 256 of the limiting member 25, and can slide in the first groove 256. The elastic member 35 can be sleeved on the main body 311 of the piston shaft 33. The assembly end 315 of the piston shaft 31 can be fixedly mounted in the assembly groove 331 of the piston 33, and the sealing member 37 can be sleeved on the receiving groove 335 of the piston 33. The piston 33 can be received in the cylinder 21 from the second opening 215 to the first opening 213. Then, the outer surface of the resisting portion 253 can be resisted against the inner surface 211 of cylinder 21 adjacent to the second opening 215, the shaft 33 can be mounted adjacent to the first opening 213 adjacent to the cylinder 21. The resisting portion 253 of the limiting member 25 can define the second chamber 27. The sealing portion 231 of the sealing head 23 can be inserted into the cylinder 21 through the first opening 213, then the sealing portion 231 and the shaft 33 can define the first chamber 26, communicating with the air channel 237. Finally, the air port 80 can be inserted into the sealing portion 231 through the access hole 238.

In use, the air source can be inserted into the air port 80, and the gas can flow into the first chamber 26 through the air channel 237. The shaft 33 can move in the axis toward the second opening 215 from the inner surface 211 of the cylinder 21 under the pressure, and the elastic member 35 can be compressed. The piston shaft 31 can move in the axis with the clamping member 50 toward the second opening 215. When the clamping member 53 extends beyond the limiting member 25, the four clamp pieces 531 are not pressed by the frustoconical shaped inner surface of the limiting member 255, and the four clamp pieces 531 are spaced with each other. At this time, the cutting tool can be inserted into the clamp hole 535, and the air source can be cutdown. The elastic member 35 can deform when the pressure is emitted, thus the piston 33 can be driven to move toward the first opening 213 of the cylinder 21, driving the clamping member 50 to move toward the second opening 215. When the clamping portion 53 of the clamping member 50 can be received in the third receiving hole 258, the frustoconical shaped inner surface of the limiting member 255 radially presses the clamping portion 53, thereby the four clamp pieces 531 can be compressed radially and the cutting tool can be clamped firmly in the clamping hole 535.

In the embodiment, the clamping apparatus 100 is a pneumatic clamping apparatus which is driven by pressure. The pressure drives the piston 33 to move along the cylinder 21 in the axis, whereby the clamping member 50 is extended beyond the limiting member 25 to assemble the cutting tool. The clamping apparatus 100 is simple, and it is convenient to insert and remove the cutting tool. The clamping portion 53 of the clamping member 50 is substantially frustoconical shaped and consists of four clamp pieces 531. When there is no external force, the four clamp pieces 531 are opened naturally and are spaced from each other. The inner surface of the limiting portion 255 of the limiting member 25 is frustoconical shaped. When the clamping portion 53 moves back to the third receiving hole 258, the frustoconical shaped inner surface of the limiting portion 255 generates a radial compression force to the clamping portion 53, forcing each clamp piece 531 to tighten, thereby the cutting tool can be firmly clamped by the clamp pieces 531. The clamp hole 535 and the cutting bar contact completely, and there is no large force clamping the cutting tool causing damage to the cutter bar. The clamp hole 535 is positioned in the middle portion of the clamping portion 53, and the four clamp pieces 531 are received in the clamping portion 255. The limiting portion 255 generates same compression force to the four clamp pieces 531 when clamping the cutting tool tightly, thereby each clamp piece 531 generates a same clamp force to the cutting tool. As a result, the cutting tool is clamped and balanced in the clamping apparatus 100.

The air port 80 can be omitted, and the air source can be inserted into the access hole 238 directly.

The guiding member 38 can be omitted, and the piston shaft 31 can be directly received in the first receiving hole 252 of the limiting member 25.

The number of the clamp pieces 531 can be, but not limited to, two, three, four, five. The clamp pieces 531 can be positioned asymmetrically.

It is believed that the present embodiments and their advantages will be understood from the foregoing description, and it will be apparent that various changes can be made thereto without departing from the spirit and scope of the embodiments or sacrificing all of its material advantages.

What is claimed is:

1. A clamping apparatus comprising:
a clamping member, a cylinder assembly and a transmission assembly assembled in the cylinder assembly, wherein the cylinder assembly comprises a cylinder, a sealing head positioned at one end of the cylinder, and a limiting member positioned at the other end of the cylinder;
the sealing head defines an air channel communicated with the cylinder, the limiting member comprises a limiting portion connected with the inner of the cylinder which including an inner surface having a frustoconical shape;
the transmission assembly includes a piston shaft, a piston sleeved on one end of the piston shaft, and an elastic member sleeved on the piston shaft;
the piston and the elastic member are both received in the cylinder;
one end of the elastic member resists against the piston, the other end of the elastic member resists against the limiting member, and one end of the piston shaft away from the piston is connected to the clamping member;
the clamping member is received in the liming member, and includes a clamping portion connected with one end of the piston shaft, the clamping portion is received in the limiting portion and has a shape matched with the frustoconical shaped inner surface of the limiting portion; and
the clamping portion defines a clamping hole in the middle portion thereof.

2. The clamping apparatus as claimed in claim 1, wherein the clamping portion further comprises a plurality of clamp pieces positioned symmetrical to each other, and evenly spaced with each other.

3. The clamping apparatus as claimed in claim 1, wherein each clamp piece further comprises:
a first side surface and a second side surface opposite to the first side surface;
the first side surface is positioned on one side of the clamp piece adjacent to the limiting portion, having a shape matched with the inner surface of the limiting portion;
the first side surfaces of the clamp pieces cooperatively define a frustoconical shape matched with the limiting member; and
the second side surface is a concave surface, and the second side surfaces of the clamp pieces cooperatively define the clamp hole.

4. The clamping apparatus as claimed in claim 1, wherein the sealing head further comprises:
a sealing portion and an assembly portion protruding from one end of the sealing portion;
the end of the sealing portion away from the assembly portion is a connecting end, and the connecting end is received in the cylinder; and
the air channel is defined at the end surface of the connecting end and toward the assembly portion, the side surface of the sealing portion away from the connecting end defines an access hole communicated with the air channel, and the assembly portion extends beyond the cylinder.

5. The clamping apparatus as claimed in claim 1, wherein the clamping apparatus further comprises an air port inserted into the sealing head through the access hole.

6. The clamping apparatus as claimed in claim 1, wherein the outer surface of the piston defines a receiving groove, the transmission assembly further comprises a sealing member, and the sealing member is received in the receiving groove.

7. The clamping apparatus as claimed in claim 1, wherein the piston shaft further comprises a main body and an assembly end formed at one end of the main body, the main body and the assembly end are received in the cylinder, the piston defines an assembly groove along an axis, and the assembly end is fixedly mounted in the assembly groove.

8. The clamping apparatus as claimed in claim 4, wherein the limiting member further comprises:
a resisting portion formed at one end of the limiting end, the resisting portion fixedly is connected with the cylinder, and the inner surface of the resisting portion defines a first groove along a axis;
the piston shaft further comprises a fixing portion fixedly connected with the clamping member, and the fixing portion is formed at one end of the main body away from the assembly end;
the side surface of the end portion defines a second groove opposite to the first groove;
the transmission assembly further comprises a guiding member, and one part of the guiding member is fixedly mounted in the first groove; and
the other part of the guiding member is mounted in the second groove, and the other part of the guiding member can slide in the second groove.

9. The clamping apparatus as claimed in claim 8, wherein the clamping member further comprises:
a connecting portion protruding from on end of the clamping portion;
the connecting portion comprises a main portion and an end portion protruding from one end of the main portion away from the clamping portion; and
the end portion is fixedly connected with the fixing end of the piston shaft, the side surface of the main portion defines a plurality of through holes.

10. The clamping apparatus as claimed in claim 1, wherein the cylinder is divided to a first chamber and a second chamber by the piston, the first chamber is positioned between the piston and the sealing head, and communicates with the air channel; the second chamber is positioned between the piston and the limiting member, the elastic member is received in the second chamber, and the elastic member resists between the piston and the limiting member.
